(19) United States
(12) Patent Application Publication
(10) Pub. No.: US 2006/0063764 A1
(43) Pub. Date: Mar. 23, 2006

(54) Insect repellents

(75) Inventor: Markus Gautschi, Zeiningen (CH)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/518,730

(22) PCT Filed: Jun. 20, 2003
(86) PCT No.: PCT/CH03/00403

§ 371 Date: Dec. 20, 2004

(30) Foreign Application Priority Data
Jun. 21, 2002 (GB) 0214342.8

(51) Int. Cl. A01N 25/00; A01N 43/40; A01N 43/36; A01N 47/10

(52) U.S. Cl. 514/237.5; 514/317; 514/423; 514/484; 424/405

(57) ABSTRACT

Use of an N-substituted p-menthane carboxamide as an active ingredient in an insect repellent composition, which has little or no odour and which is substantially non-toxic for human, pet and livestock.

The present invention relates to compounds having insect repellent characteristics and to compositions containing same.

Many insects are known as a nuisance and some insect genera even represent a health hazard. Therefore, many efforts have been made to eradicate or at least to control these pests. One method of insect eradication is through the use of synthetically produced insecticides. However, certain insect genera may develop resistance to some whilst others have undesirable effects on human and other animal life, such that their use must be strictly regulated or even forbidden.

Naturally-occurring substances are also known to display insect repellent properties, for example citronella oil, tolu and Peru balsams, camphor and various eucalyptus. However, many possess olfactory properties that makes unacceptable their use in compositions that also contain a perfume, at least in amounts required to have repellent effects.

The prior art has continued to propose highly effective insect repellent compounds that have low, or substantially no odour. Thus, in U.S. Pat. No. 5,182,305 N-aryl and N-cycloalkyl neoalkanamides are described. In U.S. Pat. No. 5,391,578 N-lower alkyl neoalkanamides are described as being superior to DEET in long lasting effectiveness of the insect repellency. In WO 00/16738 menthyl 2-pyrrolidone-5-carboxylate are described to be an effective insect repellent, comparable to DEET. Finally, in WO 02/15692, there are described compositions containing certain menthane carboxamides having excellent insect repellent properties.

These prior art efforts reflect the consumer demand for improved insect repellent compounds that are not harmful to the user or the environment, and yet which are highly effective against target insect populations. Furthermore, as the end-uses of such compounds are in high-volume, low-price or commodity products, price sensitivity is an issue that has to be addressed in the development of new compounds.

There has now been found a new category of compounds having interesting insect repellent properties that meet the requirements set forth in the preceding paragraph. Thus the invention provides in a first aspect the use as an insect repellent of a compound of the formula 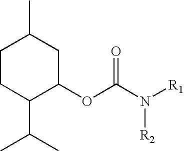
wherein,
R₁ and R₂ are independently selected from the group consisting of H; an aliphatic residue having 1 to 20 carbon atoms, or a cycloaliphatic residue having 5 to 14 carbon atoms, or an aliphatic or cycloaliphatic residue aforementioned containing one or more hetero-atoms selected from O, N or S; an aryl or heteroaryl group having from 6 to 14 carbon atoms and wherein hetero-atoms are selected from O, N or S; or any of the afore-mentioned groups substituted with a group selected from, C₁₋₄ alkyl, C₁₋₄ alkoxy, C₂₋₄ alkenyl, aryl or heteroaryl as defined above, aryloxy, amino-, amido-, ester, keto-, hydroxyl, and halogen, e.g. Cl, Br or I, or
R₁ and R₂ together with the nitrogen atom to which they are attached form a 5- or 6-membered ring that may optionally contain additional hetero-atoms selected from O, N or S.

Preferred groups R₁ and R₂ may be selected from alkyl, e.g. C₁₋₄ alkyl, more particularly methyl, ethyl, n or iso propyl, or n or sec butyl, cycloalkyl, e.g. having 5- or 6-carbon atoms or phenyl.

Most preferred groups R₁ and R₂ are those groups provided on the compounds of Example 1 hereinunder.

The compounds n-butyl-carbamic acid (−)-menthyl ester; iso-butyl-carbamic acid (−)-menthyl ester; diethyl-carbamic acid (−)-menthyl ester; morpholine-4-carboxylic acid (−)-menthyl ester; and 3-[(−)-menthoxy-carbonylamino]-propionic acid ester have interesting insect repellent properties and these compounds form another aspect of the invention.

The compounds defined hereinabove display good repellent activity against insects, in particular against cockroaches. At the same they are safe to be applied to the human body, pets and livestock, or on or against surfaces which may be contacted by humans, pets or livestock. The compounds also possess good substantivity, thereby providing long-lasting activity against insect infestations on surfaces to which they are applied. Furthermore, the compounds possess little or no odour, which makes them suitable for use in perfumed compositions. It is possible to use more than one such compound in an application.

The compounds of the invention have 3 chiral centres, giving rise to 8 stereoisomers. Thus, all possible stereoisomers are included in the scope of the present invention. However, in general, compounds having the stereo-chemistry set forth below 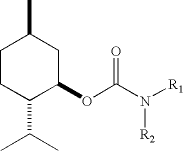
derived from the naturally occurring menthol [(−)3-p-menthanol] are preferred.

In a preferred embodiment of the present invention, there is provided the use as an insect repellent of a compound or mixture of compounds selected from the compounds set forth in Example 1 below.

Compounds of the present invention may be prepared in a straightforward manner. For example, menthol may be reacted with a chloroformate bearing the groups R₁ and R₂ under alkaline conditions in a manner known in the art. The chloroformates are either commercially available or can be synthesised from known starting materials according to synthetic procedures known to the art. Further and more specific information regarding the syntheses of the compounds is set forth in the Examples.

In another aspect of the present invention there is provided an insect repellent composition comprising at least one of the compounds hereinabove described.

The amount of compound or compounds employed in said composition may vary widely depending on a number of factors including the nature of the insect infestation that is intended to be treated and the presence or absence of other insect repellent agents in the composition. Typically, a compound or mixtures of the compounds is used at levels of from 1 ppm to 1000 ppm, although levels outside these limits may also be useful in some cases. It is possible to provide the compound or mixture of compounds as a concentrate containing typically from 0.1 to 25% by weight of the composition of the compounds or mixture of compounds. This can be then be added by the user to other ingredients to give an end-product having the desired concentration.

Compositions containing a compound or mixtures of compounds of the present invention may be applied to objects in need of protection against insects, either directly, in liquid solution or dispersion, as aerosols or air-sprays, or dispersed in a powdered carrier or in a suitable composition. Compositions which may be useful to repel insects are, for example, detergent compositions, cleaning compositions, paints, wallpaper, upholstery and/or rug shampoos, liquid soaps, soap bars, floor polishes, floor waxes and furniture polishes. Compositions which are useful to repel insects from the human body are also included in the scope of the present invention and include compositions such as fine fragrances, colognes, skin creams, sun creams, skin lotions, deodorants, talcs, bath oils, soaps, shampoos, hair conditioners and styling agents.

The compositions of the present invention may comprise a compound or compounds of the present invention in combination with other known insect repellents, including, but not limited to, N,N-diethyl-m-toluamide (DEET), N,N-diethyl-benzamide, menthyl 2-pyrrolidone-5-carboxylate, N-aryl and N-cycloalkyl neoalkanamides, N-lower alkyl neoalkanamides and nepetalactone. The compositions of the present invention may also comprise natural oils known for their insect repellent characteristics. Examples for such oils include, without limiting, e.g. citronella oil, catnip oil, eucalyptus oil, cypress oil, galbanum oil, tolu and Peru balsams.

A compound of the present invention or mixtures thereof may also be used in conjunction with at least one insecticide in order to repel insects from one area and toward the location, where the insecticide is applied to avoid the action of the insecticide in a special area, for example in areas containing foodstuffs. Alternatively, they may be formulated with insecticides so that after the repellent activity has diminished the treated area will still not be safe for insects.

A compound or mixtures of compounds for use in the present invention may additionally comprise at least one fragrance compound. Such fragrance compounds may be of natural and/or synthetic origin, examples for such natural and synthetic fragrance ingredients can be found e.g. in “Perfume and Flavour Materials of Natural Origin”, S. Arctander, Ed., Elizabeth, N.J., 1960 and “Perfume and Flavour Chemicals”, S. Arctander, Ed., Vol. I & II, Allured Publishing Corporation, Carol Stream, USA, 1994.

Such compositions may additionally contain solvents. Solvents that may be used are known to those skilled in the art and include ethanol, ethylene glycol, propylene glycol, diethyl phthalate and dimethyl phthalate. A preferred solvent is dimethyl phthalate, which is known for its insect repellent characteristics.

The compositions of the present invention may comprise other art-recognised ingredients normally used in such formulations. These include antifoaming agents, anti-microbial agents, anti-oxidants, anti-redeposition agents, bleaches, colorants, emulsifiers, enzymes, fats, fluorescent materials, fungicides, hydrotropes, moisturisers, optical brighteners, perfume carriers, perfume, preservatives, proteins, silicones, soil release agents, solubilisers, sugar derivatives, sun screens, surfactants, vitamins and waxes.

Compounds for use in the present invention have useful properties both as contact and vapour repellent. They are superior to various commercial insect repellents in repelling action, especially against German cockroaches, which are considered to be one of the most difficult household pests to control. Due to their low vapour pressure, the compounds are long-lasting on surfaces to which they have been applied. The long-lasting insect repellency may last up to 2-3 weeks after topical application, depending on the concentration used. Furthermore, the compounds are sufficiently stable in compositions being object of the present invention to maintain their insect repellency.

Compositions for use in the present invention may also be incorporated in various materials during their manufacturing process. Methods for preparing a product comprising a composition according to the present invention by incorporating said composition into the product during extrusion are preferred.

In addition to their effectiveness against German cockroaches, compositions formulated according to the present invention are also effective against other insects such as ants, bees, fleas, flies, hornets, mosquitoes, moths, silverfish, and wasps, and against arachnids such as mites, spiders and ticks.

The effectiveness against mosquitoes is important also for economic reasons, especially against the genera Anopheles (which is a known carrier of malaria and transmits also filariasis and encephalitis), Culex (which is a carrier of viral encephalitis and filariasis) and Aedes (which carries yellow fever, dengue and encephalitis). From the latter genus, the activity against Aedes aegypti is especially important.

Products that may benefit from the addition or incorporation of compounds and/or compositions provided by this invention include, but are not restricted to, household products, industrial cleansing products, personal care products, and pet or livestock care products. In addition, the invention also provides covering materials especially floor, wall and furniture coverings, fabrics and plastics materials comprising a composition or compounds as hereinabove defined. The invention therefore also provides a method of repelling insects by the application to a substrate of a preparation comprising at least one compound as hereinabove described.

The invention is now further described, by way of illustration, in the following non-limiting examples.

### EXAMPLE 1

General Procedure for the Synthesis of (−)-Menthyl Carbamates:

To a mechanically stirred solution of a corresponding amine (0.4 mol, 5 equiv.) in toluene (100 ml), cooled to 5° C. in an ice-water bath, was added dropwise a solution of (−)-menthyl chloroformate (17.5 g, 0.08 mol, 1 equiv.) in toluene (20 ml) within 0.5 h. The temperature was kept between 5 and 15° C. with cooling. The resulting suspension was allowed to warm to room temperature and stirring continued until the reaction was complete according to TLC analysis (0.5 to 3 h).

The mixture was poured into ice/water (300 ml), extracted with toluene (2×200 ml) and the organic phases were each washed with aqueous hydrochloric acid (5%, 200 ml), water (200 ml) and brine (200 ml). The combined organic layers were dried over sodium sulphate and concentrated in vacuo to give the crude carbamate. (In the case of methylamine and ethylamine, were ethanolic solutions were used, the reaction mixture remains a solution and ethanol needs to be removed prior to aqueous work-up.) The crudes were either used without purification or purified by re-crystallisation from hexane or ‘Kugelrohr’ distilled to yield the clean (−)-menthyl carbamates in 75 to 90%.
Characterisation of (−)-Menthyl Carbamates: 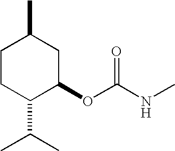
Methyl-carbamic acid (−)-menthyl ester

mp. 108-110° C. (hexane), white solid

¹H-NMR (400 MHz, CDCl₃, coupling constants in Hz): 0.79 (3H, d, J 7, Me); 0.80-0.98 (2H, m, 2×CH); 0.89 (6H, d, J 7, Me₂); 1.06 (1H, dq, J 13, 4, CH); 1.29 (1H, brt, J 11, CH); 1.42-1.55 (1H, m, CH); 1.60-1.72 (2H, m, 2×CH); 1.86-1.98 (1H, m, CH); 2.01-2.09 (1H, m, CH); 2.79 (3H, d, J 5, MeNH); 4.28-4.57 (1H, brm, NH); 4.55 (1H, dt, J 11, 4, CHOCO).

IR (νₘₐₓ, cm⁻¹, ATR): 3377w, 2961m, 1688s, 1525s, 1258s, 1139s.

MS [m/z (EI)]: 213 (M⁺, <1%), 138 (70), 123 (41), 95 (100), 81 (73), 55 (56), 41 (47). 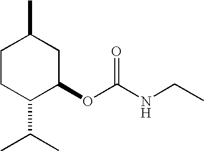
Ethyl-carbamic acid (−)-menthyl ester

mp. 55-56° C. (hexane), white solid

¹H-NMR (400 MHz, CDCl₃, coupling constants in Hz): 0.79 (3H, d, J 7, Me); 0.81-0.99 (2H, m, 2×CH); 0.89 (6H, d, J 7, Me₂); 1.05 (1H, dq, J 13, 4, CH); 1.13 (3H, t, J 7, CH₂Me); 1.28 (1H, brt, J 11, CH); 1.43-1.55 (1H, m, CH); 1.61-1.72 (2H, m, 2×CH); 1.86-1.99 (1H, m, CH); 2.01-2.09 (1H, m, CH); 3.14-3.27 (2H, brm, CH₂NH); 4.26-4.65 (1H, brm, NH); 4.48-4.61 (1H, brm, CHOCO).

IR (νₘₐₓ, cm⁻¹, ATR): 3377w, 2960m, 1687s, 1524s, 1249s, 1019m.

MS [m/z (EI)]: 227 (M+H⁺, <1%), 138 (65), 123 (28), 95 (100), 90 (83), 81 (82), 71 (41), 55 (57), 41 (32). 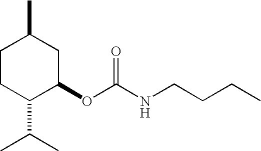
Butyl-carbamic acid (−)-menthyl ester

mp. 60-62° C. (hexane), white solid

¹H-NMR (400 MHz, CDCl₃, coupling constants in Hz): 0.79 (3H, d, J 7, Me); 0.80-0.98 (2H, m, 2×CH); 0.89 (6H, d, J 7, Me₂); 0.92 (3H, t, J 7, CH₂Me); 1.06 (1H, dq, J 13, 4, CH); 1.28 (1H, brt, J 11, CH); 1.31-1.39 (2H, m, CH₂Me); 1.41-1.55 (3H, m, CH and CH₂); 1.61-1.72 (2H, m, 2×CH); 1.87-1.98 (1H, m, CH); 2.00-2.09 (1H, m, CH); 3.11-3.23 (2H, brm, CH₂NH); 4.32-4.65 (1H, brm, NH); 4.48-4.61 (1H, brm, CHOCO).

IR (νₘₐₓ, cm⁻¹, ATR): 3369w, 2957m, 1686s, 1525s, 1240s, 1023m.

MS [m/z (EI)]: 138 (M-HOCONHBu⁺, 26%), 123 (20), 118 (18), 95 (59), 81 (48), 71 (26), 56 (61), 41 (100), 27 (34). 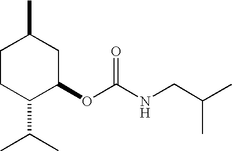
Isobutyl-carbamic acid (−)-menthyl ester

mp. 99-102° C. (hexane), white solid

¹H-NMR (400 MHz, CDCl₃, coupling constants in Hz): 0.79 (3H, d, J 7, Me); 0.80-0.98 (2H, m, 2×CH); 0.89 (6H, d, J 7, Me₂); 0.90 (6H, d, J 7, Me₂); 1.06 (1H, dq, J 13, 4, CH); 1.28 (1H, brt, J 11, CH); 1.42-1.53 (1H, m, CH); 1.62-1.78 (3H, m, 3×CH); 1.86-1.97 (1H, m, CH); 2.00-2.08 (1H, m, CH); 2.95-3.03 (2H, brm, CH₂NH); 4.45-4.68 (1H, brm, NH); 4.53 (1H, dt, J 11, 4, CHOCO).

IR (νₘₐₓ, cm⁻¹, ATR): 3373w, 2959m, 1687s, 1528s, 1276m, 1241s, 1144m, 1039m.

MS [m/z (EI)]: 138 (M—HOCONHiBu⁺, 28%), 123 (17), 118 (16), 95 (59), 81 (44), 71 (31), 56 (42), 43 (100), 27 (31). 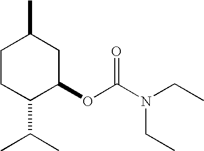
Diethyl-carbamic acid (−)-menthyl ester

bp. 90° C., 0.03 mbar, colourless liquid

¹H-NMR (400 MHz, CDCl₃, coupling constants in Hz): 0.79 (3H, d, J 7, Me); 0.87 (1H, dt, J 11, 3, CH); 0.90 (6H, d, J7, Me₂); 0.95 (1H, q, J 11, CH); 1.07 (1H, dq, J 13, 4, CH); 1.10 (6H, t, J7, 2×CH₂Me); 1.36 (1H, tt, J 11, 3, CH); 1.42-1.55 (1H, m, CH); 1.62-1.73 (2H, m, 2×CH); 1.94 (1H, ddq, J 13, 7, 3, CH); 2.02-2.10 (1H, m, CH); 3.20-3.35 (4H, brm, 2×CH₂NH); 4.57 (1H, dt, J 11, 4, CHOCO).

IR (νₘₐₓ, cm⁻¹, ATR): 2955m, 1695s, 1422m, 1271s, 1172s, 993m.

MS [m/z (EI)]: 255 (M⁺, <1%), 138 (42), 118 (91), 95 (29), 83 (100), 69 (34), 55 (48), 41 (29). 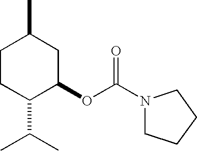
Pyrrolidine-1-carboxylic acid (−)-menthyl ester

crude product: colourless liquid

¹H-NMR (400 MHz, CDCl₃, coupling constants in Hz): 0.80 (3H, d, J7, Me); 0.88 (1H, dt, J 11, 3, CH); 0.90 (6H, d, J7, Me₂); 0.95 (1H, q, J 11, CH); 1.07 (1H, dq, J 13, 4, CH); 1.36 (1H, tt, J 11, 3, CH); 1.42-1.56 (1H, m, CH); 1.62-1.72 (2H, m, 2×CH); 1.81-1.89 (6H, m, CH₂CH₂); 1.96 (1H, ddq, J 13, 7, 3, CH); 2.05-2.13 (1H, m, CH); 3.28-3.40 (4H, brm, 2×CH₂NH); 4.55 (1H, dt, J 11, 4, CHOCO).

IR (νₘₐₓ, cm⁻¹, ATR): 2952m, 1699s, 1411s, 1100m.

MS [m/z (EI)]: 253 (M⁺, <1%), 138 (31), 116 (100), 98 (26), 95 (38), 83 (65), 69 (29), 55 (61), 41 (32). 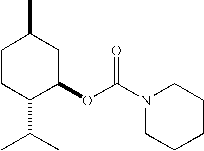
Piperidine-1-carboxylic acid (−)-menthyl ester

crude product: colourless liquid

¹H-NMR (400 MHz, CDCl₃, coupling constants in Hz): 0.79 (3H, d, J 7, Me); 0.88 (1H, dt, J 11, 3, CH); 0.91 (6H, d, J7, Me₂); 0.94 (1H, q, J 11, CH); 1.07 (1H, dq, J 13, 4, CH); 1.37 (1H, tt, J 11, 3, CH); 1.42-1.72 (9H, m, 3×CH, CH₂CH₂CH₂); 1.92 (1H, ddq, J 13, 7, 3, CH); 2.03-2.10 (1H, m, CH); 3.40 (4H, t, J6, 2×CH₂NH); 4.55 (1H, dt, J 11, 4, CHOCO).

IR (νₘₐₓ, cm⁻¹, ATR): 2933m, 1695s, 1425m, 1231m.

MS [m/z (EI)]: 267 (M³⁰ , <1%), 138 (41), 130 (100), 95 (43), 83 (66), 69 (41), 55 (47), 41 (46).
Morpholine-4-carboxylic acid (−)-menthyl ester

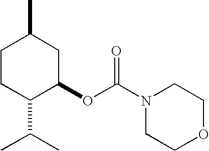

crude product: colourless liquid

¹H-NMR (400 MHz, CDCl₃, coupling constants in Hz): 0.79 (3H, d, J7, Me); 0.87 (1H, dt, J 11, 3, CH); 0.90 (6H, d, J7, Me₂); 0.95 (1H, q, J 11, CH); 1.08 (1H, dq, J 13, 4, CH); 1.36 (1H, tt, J 11, 3, CH); 1.42-1.56 (1H, m, CH); 1.63-1.72 (2H, m, 2×CH); 1.89 (1H, ddq, J 13, 7, 3, CH); 2.03-2.11 (1H, m, CH); 3.46 (4H, t, J5, 2×CH₂NH); 3.65 (4H, t, J5, 2×CH₂O); 4.58 (1H, dt, J 11, 4, CHOCO).

IR (νₘₐₓ, cm⁻¹, ATR): 2956m, 1699s, 1420m, 1238s, 1117m.

MS [m/z (EI)]: 269 (M³⁰ , <1%), 138 (61), 95 (42), 83 (100), 69 (37), 57 (41), 55 (53), 41 (33). 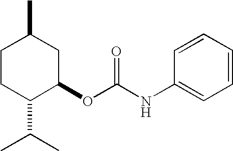
Phenyl-carbamic acid (−)-menthyl ester

mp. 111-113° C. (hexane), white solid

¹H-NMR (400 MHz, CDCl₃, coupling constants in Hz): 0.81 (3H, d, J7, Me); 0.89 (1H, dt, J 11,3, CH); 0.92 (6H, d, J7, Me₂); 1.01 (1H, q, J 11, CH); 1.10 (1H, dq, J 13, 4, CH); 1.37 (1H, tt, J 11, 3, CH); 1.45-1.58 (1H, m, CH); 1.66-1.74 (2H, m, 2×CH); 1.97 (1H, ddq, J 13, 7, 3, CH); 2.08-2.15 (1H, m, CH); 4.66 (1H, dt, J 11, 4, CHOCO); 6.54 (1H, brs, NH); 7.05 (1H, brt, J 7.5, PhH); 7.30 (2H, t, J 7.5, 2×PhH); 7.38 (2H, brd, J 7.5, 2×PhH).

IR (νₘₐₓ, cm⁻¹, ATR): 3364w, 2955m, 1697s, 1524s, 1443s, 1226s, 1050s.

MS [m/z (EI)]: 275 (M⁺, 7%), 137 (28), 119 (89), 95 (84), 83 (100), 69 (45), 55 (82), 41 (62). 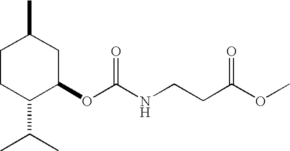
3-[(−)-menthoxy-carbonylamino]-propionic acid ester

mp. 49-51° C. (hexane), white solid

¹H-NMR (400 MHz, CDCl₃, coupling constants in Hz): 0.79 (3H, d, J 7, Me); 0.80-0.98 (2H, m, 2×CH); 0.91 (6H, d, J7, Me₂); 1.05 (1H, dq, J 13, 4, CH); 1.29 (1H, brt, J 11, CH); 1.42-1.55 (1H, m, CH); 1.62-1.73 (2H, m, 2×CH); 1.85-1.97 (1H, m, CH); 1.99-2.08 (1H, m, CH); 2.55 (2H, t, J 6, CH₂CO); 3.38-3.49 (2H, m, CH₂NH); 3.70 (3H, s, OMe); 4.53 (1H, dt, J 11, 4, CHOCO); 5.07-5.18 (1H, brm, NH).

IR (νₘₐₓ, cm⁻¹, ATR): 3362w, 2959m, 1734s, 1683s, 1530s, 1256s, 1199m, 1177s, 991m.

MS [m/z (EI)]: 286 (M+H⁺, 3%), 148 (69), 138 (100), 123 (45), 116 (53), 104 (92), 95 (91), 81 (60), 55 (37), 41 (24).

### EXAMPLE 2

The effectiveness of compounds of formula I as insect repellents is determined using German cockroaches exposed to a melamine-formaldehyde laminate surface partially treated/partially untreated with a test compound of formula I.

The study was conducted in an air-conditioned laboratory at a temperature of 22°±2° ° C. under a normal day/night cycle, using German cockroaches (Blatella Germanica) of mixed sex and age. The study was conducted over a 3 day period and the repellent effectiveness was assessed 1, 2 and 3 days after cockroach introduction.

Test Method:

A. Treatment

One half of a rectangle of laminate 40 cm×30 cm was treated at 20 mg/m² of a test compound of formula I. This was achieved by soaking a paper wipe (“Rag on a Roll” ca 20 cm×20 cm) in a solution of the test compound in ethanol, squeezing out the excess liquid and wiping over the surface to give the required coverage. This was checked by weighing the cloth after application. The surface was allowed to dry. The other half of the rectangle was wiped with ethanol alone (untreated surface).

B. Bioassays

The treated laminate rectangle was placed on the bench and a plastic container was placed on the rectangle. This had been treated with “Fluon” (trade mark), a sprayable fluoropolymer, to prevent cockroach escape.

Two sheets of laminate (10 cm×10 cm) were placed on the laminate, one on the treated surface and one on the untreated surface. This acted as a cockroach harbourage. The laminate sheet to be used in the treated section was treated at the same rate as the treated laminate. The laminate was placed on two 1 cm high bottle tops to allow cockroaches access under the laminate.

20 German cockroaches were added (5 adults and 15 nymphs) to the centre of the laminate. No food and water was supplied for these cockroaches.

At 1, 2 and 3 days after cockroach introduction the number of cockroaches under each harbourage was counted. After each count the harbourage position was changed to avoid the possibility of habituation to one location, the harbourages were replaced and new cockroaches were added to replace any dead cockroaches.

The above was repeated 3 times to provide a total of 4 replicates.

C. Repellency Results for Compound Methyl-Carbamic Acid (−)-Menthyl Ester

| Time After | | | | | |
|---|---|---|---|---|---|
| Cockroach | | Number of Cockroaches present (n = 20) | | | |
| Introduction | | Treated | Untreated | | |
| (Days) | Replicate | Section | Section | Dead | Total |
| 1 | 1 | 0 | 20 | 0 | 20 |
| | 2 | 0 | 19 | 1 | 20 |
| | 3 | 3 | 17 | 0 | 20 |
| | 4 | 1 | 19 | 0 | 20 |
| | Total | 4 | 75 | 1 | 80 |
| 2 | 1 | 1 | 19 | 0 | 20 |
| | 2 | 0 | 19 | 1 | 20 |
| | 3 | 0 | 20 | 0 | 20 |
| | 4 | 1 | 19 | 0 | 20 |
| | Total | 2 | 77 | 1 | 80 |
| 3 | 1 | 0 | 20 | 0 | 20 |
| | 2 | 0 | 20 | 0 | 20 |
| | 3 | 1 | 19 | 0 | 20 |
| | 4 | 0 | 20 | 0 | 20 |
| | Total | 1 | 79 | 0 | 80 |

### EXAMPLE 3

The methodology of Example 2 was repeated for all of the compounds set forth in Example 1. The results are presented in the following table.

| | Days | | |
|---|---|---|---|
| | after | | |
| | treat- | | |
| Structure | ment | Percentage | |
| | Days | Present on | |
| | after | | un- |
| | treat- | treated | treated |
| Compound | ment | section | section |
| 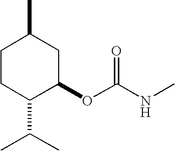 | 1 2 3 Average | 5.1 2.5 1.3 3.0 | 94.9 97.5 98.7 97.0 |
| 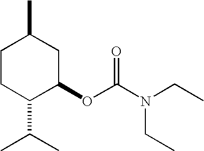 | 1 2 3 Average | 7.6 2.5 2.5 4.2 | 92.4 97.5 97.5 95.8 |
| 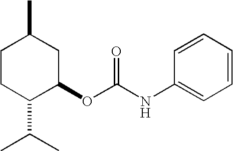 | 1 2 3 Average | 2.5 3.7 2.5 2.9 | 97.5 96.3 97.5 97.1 |
| 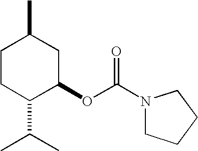 | 1 2 3 Average | 2.5 7.5 12.7 7.6 | 97.5 92.5 87.3 92.4 |
| 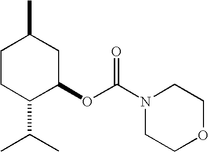 | 1 2 3 Average | 17.5 17.5 25.0 20.0 | 82.5 82.5 75.0 80.0 |
| 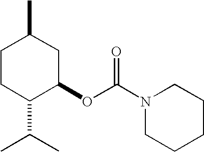 | 1 2 3 Average | 10.0 11.3 3.9 8.4 | 90.0 88.7 96.1 91.6 |
| 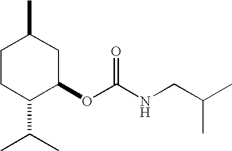 | 1 2 3 Average | 31.3 17.5 16.3 21.7 | 68.7 82.5 83.7 78.3 |
| 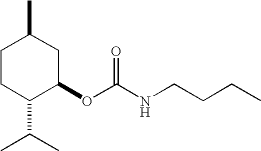 | 1 2 3 Average | 6.3 17.5 7.5 10.5 | 93.7 82.5 92.5 89.6 |
| 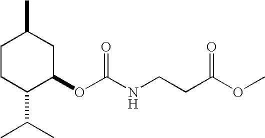 | 1 2 3 Average | 11.4 2.5 10.0 8.0 | 88.6 97.5 90.0 92.0 |

1. Use as an insect repellent of a compound of the formula 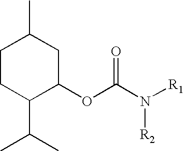
wherein,
R₁ and R₂ are independently selected from the group consisting of H; an aliphatic residue having 1 to 20 carbon atoms, or a cycloaliphatic residue having 5 to 14 carbon atoms, or an aliphatic or cycloaliphatic residue aforementioned containing one or more hetero-atoms selected from O, N or S; an aryl or heteroaryl group having from 6 to 14 carbon atoms and wherein hetero-atoms are selected from O, N or S; or any of the afore-mentioned groups substituted with a group selected from, C₁₋₄ alkyl, C₁₋₄ alkoxy, C₂₋₄ alkenyl, aryl or heteroaryl as defined above, aryloxy, amino-, amido-, ester, keto-, hydroxyl, and halogen, or
R₁ and R₂ together with the nitrogen atom to which they are attached form a 5- or 6-membered ring that may optionally contain additional hetero-atoms selected from O, N or S.

2. Use according to claim 1 wherein the compound is selected from the group consisting of
Methyl-carbamic acid (−)-menthyl ester;
Ethyl-carbamic acid (−)-menthyl ester;
Butyl-carbamic acid (−)-menthyl ester;
Isobutyl-carbamic acid (−)-menthyl ester;
Diethyl-carbamic acid (−)-menthyl ester;
Pyrrolidine-1-carboxylic acid (−)-menthyl ester;
Piperidine-1-carboxylic acid (−)-menthyl ester;
Morpholine-4-carboxylic acid (−)-menthyl ester;
Phenyl-carbamic acid (−)-menthyl ester; and
3-[(−)-menthoxy-carbonylamino]-propionic acid ester.

3. A compound selected from the group consisting of n-butyl-carbamic acid (−)-menthyl ester; iso-butyl-carbamic acid (−)-menthyl ester; diethyl-carbamic acid (−)-menthyl ester; morpholine-4-carboxylic acid (−)-menthyl ester; and 3-[(−)-menthoxy-carbonylamino]-propionic acid ester.

4. A composition comprising a compound according to claim 1 as defined in any of the preceding claims in an insect-repellent amount.

5. A composition according to claim 4 comprising at least one additional insect repellent.

6. A composition according to claim 4 comprising additionally at least one insecticide.

7. A composition according to claim 4 comprising additionally at least one fragrance ingredient.

8. A method of repelling insects by applying to a substrate a preparation comprising at least one compound of the formula 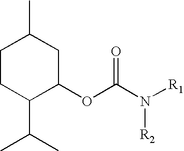
wherein,
R₁ and R₂ are independently selected from the group consisting of H; an aliphatic residue having 1 to 20 carbon atoms, or a cycloaliphatic residue having 5 to 14 carbon atoms, or an aliphatic or cycloaliphatic residue aforementioned containing one or more hetero-atoms selected from O, N or S; an aryl or heteroaryl group having from 6 to 14 carbon atoms and wherein hetero-atoms are selected from O, N or S; or any of the afore-mentioned groups substituted with a group selected from, C₁₋₄ alkyl, C₁₋₄ alkoxy, C₂₋₄ alkenyl, aryl or heteroaryl as defined above, aryloxy, amino-, amido-, ester, keto-, hydroxyl, and halogen, or
R₁ and R₂ together with the nitrogen atom to which they are attached form a 5- or 6-membered ring that may optionally contain additional hetero-atoms selected from O, N or S.
